(19) United States
(12) Patent Application Publication
(10) Pub. No.: US 2005/0203717 A1
(43) Pub. Date: Sep. 15, 2005

(54) AUTOMATED TESTING SYSTEM, METHOD AND PROGRAM PRODUCT USING TESTING MAP

(75) Inventor: Rakesh K. Parimi, Beacon, NY (US)

Correspondence Address: HOFFMAN WARNICK & D'ALESSANDRO, LLC, 75 STATE STREET, 14TH FL, ALBANY, NY, 12207, US

(73) Assignee: INTERNATIONAL BUSINESS MACHINES CORPORATION, Armonk, NY (US)

(21) Appl. No.: 10/708,562

(22) Filed: Mar. 11, 2004

(51) Int. Cl. G06F 11/00

(52) U.S. Cl. 702/188

(57) ABSTRACT

A method, system and program product are disclosed for performing automatic testing of a system including a plurality of modules in which at least two modules lack a predetermined communication mechanism. In particular, the invention performs automated testing of such systems by finding and applying a logical correlation on test results for automated generation of a test map. Each test map includes a sequence of test scripts to be run by the modules and/or interface points. The test map generation can be based on test results from previous tests such that the invention learns, improves and obtains more functionality.

### BACKGROUND OF INVENTION

The present invention relates to automated testing of a system. More particularly, the present invention relates to an automated testing system, method and program product that generate a test map including unique test scripts depending on modules and interface points to be tested.

Diversified systems including differently architected modules that each have their own software platform are used throughout industry. Software testing of systems presents a challenge for software testers. Manual testing of such systems alone does not provide a mechanism for capturing all “bugs” and does not provide an easy mechanism for reproducing those bugs. In fact, manual testing does not capture all the bugs and sometimes fails to perform a “good” integration or regression test. In such an event, the bugs are not discovered until the system is completely deployed. By then, it has become very time-consuming and expensive to correct the bugs. This problem of discovering bugs also presents an enormous task because of the nature of the complex systems involved and the amount of testing required and the amount of data analysis required.

An illustrative system is a semiconductor manufacturing facility. The advent of highly automated facilities has resulted in implementation of a wide variety of system modules, many of which are deployed on their own unique software platforms. For example, system modules may be deployed on different platforms, such as Red Hat Linux and Windows 2000. Adding to the complexity, modules may communicate with each other using different messaging protocols including, for example, CORBA, ORBIX, HTTP, FTP, MQ (pub/sub and point-to-point) and DB2.

The diversity of these system has made manually investigating a software integration point failure, encountered when the systems are deployed, extremely time consuming and sometimes impossible. In particular, conventional automated testing approaches are mostly concentrated on a single system module, a single software platform and/or a single interface point, i.e., testing is compartmentalized to a given module, platform or interface point. Accordingly, human involvement is necessary for each module, platform and interface point. Testing across a large system, therefore, is very cumbersome. The problem is exponentially magnified when the testing procedures includes testing, correcting and then re-testing until any problem is removed. The problem is also magnified where a failure by one module results in failures to others. As a result, software testing of each module and each interface point between modules is oftentimes avoided, resulting in bug-ridden system implementation.

Another problem that compartmentalized testing of systems creates is that data that may be used to educate and improve testing is not automatically leveraged. That is, testing improvements are only implemented if a human tester observes, recognizes and implements the potential improvements.

In view of the foregoing, there is a need in the art for an automated software testing system, method and program product that does not suffer from the problems of the related art.

### SUMMARY OF INVENTION

The invention includes a method, system and program product for performing automatic testing of a system including a plurality of modules in which at least two modules lack a predetermined communication mechanism. In particular, the invention performs automated testing of such systems by finding and applying a logical correlation on test results for automated generation of a test map. Each test map includes a sequence of test scripts to be run by the modules and/or interface points. The test map generation can be based on test results from previous tests such that the invention learns, improves and obtains more functionality.

A first aspect of the invention is directed to a method for performing automatic testing of a system including a plurality of modules in which at least two modules lack a predetermined communication mechanism, the method comprising the steps of: establishing at least one test goal for testing regarding at least one of a module and an interface point between modules; providing at least one test script configured to conduct a test at each module and each interface point; generating a test map for each test goal, each test map configured to run at least one test script for each module and each interface point in accordance with the test goal; and automatically testing the system using each test map.

A second aspect of the invention is directed to a computer program product comprising a computer useable medium having computer readable program code embodied therein for performing automatic testing of a system including a plurality of modules in which at least two modules lack a predetermined communication mechanism, the program product comprising: program code configured to establish at least one test goal for testing regarding at least one of a module and an interface point between modules, wherein at least one test script configured to conduct a test is provided at each module and each interface point; program code configured to generate a test map for each test goal, each test map configured to run at least one test script for each module and each interface point in accordance with the test goal; and program code configured to automatically test the system using each test map.

A third aspect of the invention is directed to a system for performing automatic testing of a system including a plurality of modules in which at least two modules lack a predetermined communication mechanism, the system comprising: means for establishing at least one test goal for testing regarding at least one of a module and an interface point between modules, wherein at least one test script configured to conduct a test is provided at each module and each interface point; means for generating a test map for each test goal, each test map configured to run at least one test script for each module and each interface point in accordance with the test goal; and means for automatically testing the system using each test map.

The foregoing and other features of the invention will be apparent from the following more particular description of embodiments of the invention.

### BRIEF DESCRIPTION OF DRAWINGS

The embodiments of this invention will be described in detail, with reference to the following figures, wherein like designations denote like elements, and wherein:

FIG. 1 shows a block diagram of an illustrative system.

FIG. 2 shows a block diagram of an automated testing system.

FIG. 3 shows a block diagram of a test map.

FIG. 4 shows a block diagram of a model rule.

FIG. 5 shows a block diagram of a test case.

FIG. 6 shows a flow diagram of operation methodology of the system of FIG. 2.

### DETAILED DESCRIPTION

For purposes of clarity only, the description includes the following sub-titles: I. Environment Overview, II. Automated Testing System Overview, III. Operation Methodology, and IV. Conclusion.

I. Environment Overview

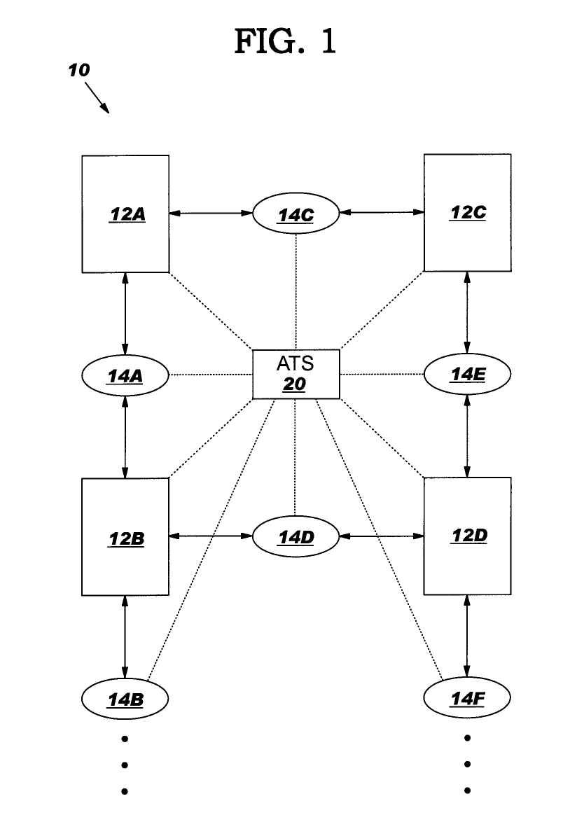

Referring to FIG. 1, a block diagram of an illustrative system 10 is illustrated. In one example, system 10 may be a semiconductor manufacturing facility that includes at least two modules 12 that may have different mechanical or electrical architecture and/or different control (software) platforms, e.g., Red Hat®Linux or Windows®2000, and lack a predetermined communication mechanism. A “module” is a component of a system of interest. In terms of a semiconductor manufacturing facility, modules 12 may include, for example, manufacturing machines such as an ion implanter or photolithography tool; environmental controls; automation equipment; system controls, or an expansive variety of other components. It should be recognized that while system 10 is described in terms of a semiconductor manufacturing facility, the teachings of the invention are applicable to practically any system for which automated testing is desired.

An “interface point” 14 is a point of communication between two modules 12. Each module 12 may interface or communicate with a wide variety of other modules 12 via interface points 14, which also may have different mechanical or electrical architecture and/or different control (software) platforms. Where an interface point 14 is a messaging protocal it may be based on, for example, CORBA, ORBIX, HTTP, FTP, MQ (pub/sub and point-to-point) or DB2. Each module 12 may have one or more interface points 14 depending on the other modules it must communicate with.

System 10 presents a much more complex environment for testing than, for example, a single computer program, where the dependencies are known and finite. In particular, changes made to any module 12 or any interface point 14 in system 10 can potentially lead to integration failures on many other modules 12 and/or interface points 14. In order to address this situation, an automated testing system 20 communicates with selective modules 12 and selective interface points 14 to perform automated testing of system 10.

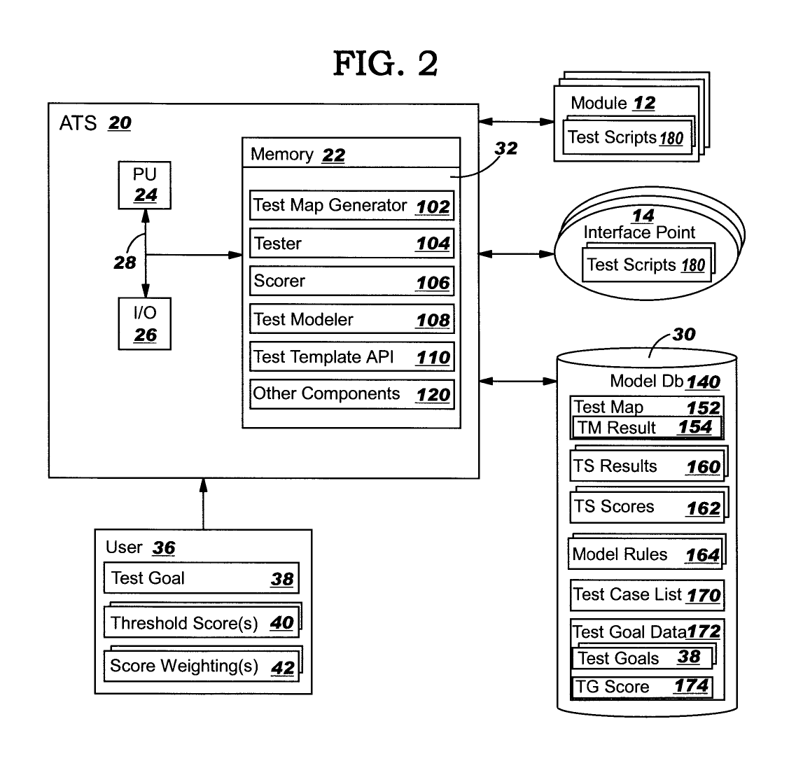

“Testing,” as used herein, may include any now known or later developed testing that can be automated including, for example, functional, integration, regression or stress testing. A “test goal” is an overall statement of what is to be achieved by a testing procedure. The scope of a test goal can vary. For example, a test goal may be very broad in coverage, for example, “test all communications between modules,” “test overhead carriage system motors,” “test photolithography tool accuracy,” etc. Alternatively, a test goal may be very precise in coverage, for example, “test that all software in anneal line can communicate,” “test that software update on machine 123 is operative,” etc. A test goal 38 (FIG. 2) also includes at least one interface point 14 and module 12 that have been identified by a user 36 (FIG. 2) as requiring testing to achieve the test goal.

II. Automated Testing System Overview

Referring to FIG. 2, a block diagram of an automated testing system 20 (hereinafter “ATS”) in accordance with the invention is illustrated. ATS 20 includes a memory 22, a processing unit (PU) 24, input/output devices (I/O) 26 and a bus 28. A database 30 may also be provided for storage of data relative to processing tasks, as will be described below. Memory 22 includes a program product 32 that, when executed by PU 24, comprises various functional capabilities described in further detail below. Memory 22 (and database 30) may comprise any known type of data storage system and/or transmission media, including magnetic media, optical media, random access memory (RAM), read only memory (ROM), a data object, etc. Moreover, memory 22 (and database 30) may reside at a single physical location comprising one or more types of data storage, or be distributed across a plurality of physical systems. PU 24 may likewise comprise a single processing unit, or a plurality of processing units distributed across one or more locations. A server computer may comprises any advanced mid-range multiprocessor-based server, such as an RS6000 from IBM, utilizing standard operating system software, which is designed to drive the operation of the particular hardware and which is compatible with other system components and I/O controllers. I/O 26 may comprise any known type of input/output device including a network system, modem, keyboard, mouse, scanner, voice recognition system, CRT, printer, disc drives, etc. Additional components, such as cache memory, communication systems, system software, etc., may also be incorporated into ATS 20.

As shown in FIG. 2, program product 32 may include a test map generator 102, a tester 104, a scorer 106, a test modeler 108, a test template application programming interface (API) 110 and other system components 120. Other system components 120 may include any other function necessary for implementation of ATS 20 not explicitly described herein.

In one embodiment, ATS 20 uses a client-server model to execute automated tests with ATS 20 acting as a server and each part, i.e., module 12 or interface point 14, to be tested acting as a client. Where necessary, a system interface (not shown) can be generated to allow ATS 20 to communicate with each client 12, 14. The system interface may include all methods and type definitions that will be used by all existing and future clients 12, 14, and perhaps classes to encapsulate errors and exceptions. System interface may also include particular client-specific components.

As will be described further, testing is implemented via a test map 152 that includes a sequence of test scripts 180 to be executed, which are stored on clients 12, 14. ATS 20 posts requests in the form of “test scripts to be performed” to each client 12, 14. Available clients 12, 14 listen to incoming requests from ATS 20 and run test scripts 180 on a first-come-first-picked-up basis. It should be recognized that other forms of request and response scheduling and prioritizations are also possible.

A user 36 request to test something is entered/selected as a test goal 38 at ATS 20. ATS 20 then broadcasts this message to listening clients 12, 14 (FIG. 1). If a client 12, 14 is currently executing test goal 38, the client does not respond to a new ATS request, i.e., only free clients respond to incoming requests from ATS 20. Free clients then respond to the request saying “I heard your request, should I execute it?” back to ATS 20. ATS 20 listens to responses from clients 12, 14, registers all the responses, and asks the first client that responded to execute the task. This request also goes as a broadcast message to all clients 12, 14. Since each broadcast message contains client identifications, i.e., clients for whom this message pertains to, there is no contention.

Turning to database 30, in one embodiment, a model database 140 is provided that stores all requisite data regarding testing including a plurality of: test maps 152 each including a test map (TM) result 154, test script (TS) results 160, test script (TS) scores 162, and model rules 164. In addition, model database 140 includes a test case list 170 and test goal data 172 including previously defined test goals 38 and respective test goal scores 174 for each. The above-mentioned data components are defined as follows:

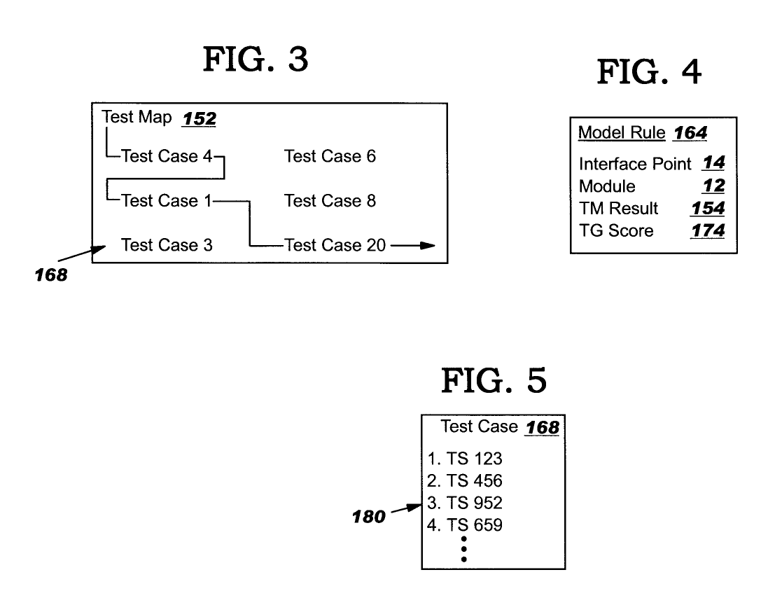

As shown in FIG. 3, a “test map” 152 is a sequence of stored test cases 168 to be run in sequence for each module 12 and interface point 14 in accordance with a test goal. As used herein, a “test case” 168 is a logical definition and/or expectation for a test. For example, referring to FIG. 1, a test that investigates whether an interface point 14A can collect certain data from a module 12A and communicate to another module may represent a “14A-12A communication test case.” An expectation may be, for example, that if input X is input to interface point 14A, then output Y results at module 12A. If this does not occur, then the test case has a failing test result. As shown in FIG. 4, each test case 168 includes one or more test scripts (TS) 180 to be run in sequence, e.g., TS 123, TS 456, TS 952, TS 659 . . . . In the example shown, test map 152 requires test cases 4, 1 and 20 to be run in sequence. Successful completion of each test case, i.e., test scripts included therein, indicates successful completion of test map 152. At least one test case 168, i.e., test script 180, failure indicates the respective test map failed.

Returning to FIG. 2, a “test script” 180 is a basic hardware and/or software module that resides at a particular client 12, 14 and performs actual testing, i.e., it executes a test case including, for example, functional, integration and/or regression testing. Each test script 180 also logs TS results 160 to model database 140.

In one embodiment, a test template API 110 provides a user with a mechanism to construct/delete/revise test goals 38, test cases 168, test scripts 180 and set up testing and set preferences, i.e., it provides all the required test management routines. In addition, test template API 110 may provide functionality to execute modeling principles on test results, as will be described further below. Preferably, test scripts 180 are detailed and modular to promote greater re-use. In addition, a super class for all test scripts 180 (i.e., super test script) can be provided for joining test scripts and providing all functionality required to run a test including, for example, logging, invoking other test scripts 180 and other functionality as desired by a user.

A “test result” is a result of a test map 152 or test script 180. Each test map 152 has exactly one associated TM result 154, and each test script 180 has exactly one associated TS result 160 stored in model database 140.

A “test script (TS) score” 162 is a score assigned to each test script 180 after execution, and indicates how productive the test script is. Each running of a test script 180 results in an assigned TS score 162, which indicates how much was tested, e.g., success/failure, how many errors, warnings, failures, errors logged, as will be described further below.

A “test goal (TG) score” 174 is an overall score assigned to each test goal 38 and components thereof, i.e., each test case 168 therein and each test script 180 therein.

As shown in FIG. 5, “model rule” 164 is a user-defined instruction that indicates preferred procedures to be followed in response to a given TM result 154 and/or TG score 174. Each model rule 164 includes interface point(s) 14 and module(s) 12 tested and TM result 154 with TG score 174. One illustrative application is: if an interface point 14 was tested for performance and resulted in a given TM result 154 (e.g., 20 seconds) and a TG score 174 is within a certain range, and a user has determined that when the given TM result 154 and specified TG score 174 comes up, it is best to conduct another particular test case to achieve improved performance (e.g., 10 seconds), a user may define a model rule 164 indicating this preferred procedure. In this fashion, a user can dynamically improve testing procedures.

III. Operational Methodology

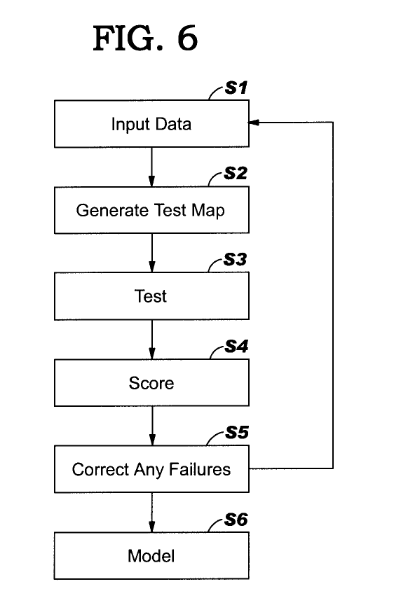

Referring to FIG. 6 in conjunction with FIG. 2, operational methodology of ATS 20 will now be described.

A. input Data

As an initial step Si, a user 36 may input any necessary data. In one embodiment, data may include at least one of a test goal 38, at least one threshold score 40 and score weighting 42. Score weighting 42 will be further defined below in the “Scoring” sub-section. A “threshold score” 40 is a minimum score necessary to trigger use of either a test goal 38 stored in model database 140 or a test script 180. Threshold score 40, hence, allows a user 36 to select how much testing is completed or how thorough testing is. That is, the higher the threshold score 40, the less test goals 38 or test scripts 180 are used, the less time is required to execute and the less things are tested.

One aspect of this step is that at least one test goal 38 is established either by a user 36 creating it by delimiting at least one module 12 or interface point 14 required to evaluate attainment of the test goal, or by selecting at least one previously created test goal 38, e.g., by selection via a graphical user interface (GUI)(not shown) from model database 140. In one embodiment, test template API 110 may provide this functionality. In terms of the former, this may be accomplished by a user 36 determining which modules 12 and interface points 14 are of interest for testing, and creating any required or desired test scripts 180 (FIG. 2) for each. In addition, a system interface allowing communication with each module 12 and/or interface point 14 may also be built. Once these preliminary steps are complete, ATS 20 can complete automated testing as described below.

For newly created test goals 38 and/or test scripts a default TG score 174 and TS score 162 may be assigned so as to provide a basis for their evaluation, as will be described below.

B. Generate Test Map

In a second step S2, test map generator (TMG) 102 generates a test map 152 for each established test goal 38. That is, TMG 102 generates a test map including at least one test script 180 for each module and each interface point in accordance with a test goal. In one embodiment, TMG 102 constructs a module list (ML) of modules 12 and a point list (PL) of interface points 14 for completion of a particular test goal. For each module 12 in list ML, a set of test scripts 180 for that module having a score greater than threshold score 40 are selected. Similarly, for each interface point in list PL, a set of test scripts 180 having a score greater than threshold score 40 are selected. The selected test scripts 180 for each module 12 and each interface point 14 constitute a test map 152. For convenience, test scripts 180 may be selected by TMG 102 as grouped together as a test case 168. In this case, TMG 102 may select from test case list 170 based on the scores of test scripts 180 in the respective test cases 168 of the list. A particular sequence of test scripts 180 may be determined, for example, based on their sequence as assigned to their respective interface point 14 and module 12. In one embodiment, module 12 test scripts are run first, followed by interface point 14 test scripts.

In one alternative embodiment, TMG 102 may evaluate a TG score 174 prior to generation of a test map 152 to determine whether execution of a test goal is advisable. In particular, TMG 102 may generate a test map 152 for a test goal 38 only if the test goal has a TG score 174 greater than a threshold score 40. In this fashion, testing of test goals 38 that are not considered important by a user 36, as indicated via threshold score 40 for a test goal, may be omitted.

In addition, in one embodiment, TMG 102 also implements model rules 164 from model database 140 by modifying test map 152, i.e., adding, deleting or revising test map 152. Where a model rule 164 dictates additional testing, test map 152 is modified to include the additional test cases, i.e., by addition of one or more test cases 168 and/or one or more test scripts 180. For example, a model rule 164 may dictate that when a module 12C is tested, interface points 14C and 14E should also be tested. In this case, TMG 102 would add any necessary test cases 168 for that testing to test map 152.

Each test map 152 is recorded in model database 140 for subsequent use by TMG 102.

C. Test

In a third step S3, automatic testing is conducted by tester 104 based on each test map 152. Testing proceeds as explained above relative to the client-server setting. As testing proceeds, TS results 160 are recorded in model database 140. TM result 154 is formulated and tested by tester 104 once all TS results 160 are gathered. As noted above, the actual testing can be any automated testing now known or later developed. The gathered TS results 160 indicate test script(s) 180 that have passed and test script(s) 180 that have failed. The TS results 160 also indicate modules 12 and/or interface point(s) 14 that were tested successfully and ones that failed. As noted above, test map 152 is a success only if all test scripts 180 therein are successful.

D. Scoring

As an optional step of the method, at step S4, scorer 106 tracks the accuracy and correctness of ATS 20 by determining a TS score 162 for each test script 180 run during a test map 152 and a TG score 174. Based on these test scores, the following items can be tracked: a) accuracy and correctness of tester 104, b) accuracy and correctness of a test map 152; and c) whether a test goal 38 was satisfied as expected. As indicated above, score weighting 42 may be input by a user 36, e.g., prior to each testing session. “Score weighting” 42 includes a weight assigned to each of a number of variables, which can be user defined, and are used to determine scores to be used as described above. Score weighting can be on any scale desired. In one example described below, the scale is from 0 to 1.0, where 1 is the most significant.

In one embodiment, TG score 174 can be calculated by evaluating weighted success versus total ratios. In one embodiment, the following four weighted ratios and score weighting can be implemented: P=number of test scripts successfully tested/number of test scripts in test goal, score weighting (WP)=0.66; Q=number of modules successfully tested/number of modules tested by test goal, score weighting (WQ)=0.89; R=number of interface points successfully tested/number of interface points tested by test map, score weighting (WR)=0.77; and H=human factor in clustering or writing test scripts and/or other human factor elements (e.g., quality of people who write test scripts), score weighting (WH)=0.9. Based on the above variables, a TG score 174 can be calculated according to the following equation: WP*P+WQ*Q+WR*R+WH*H.

If a TG score 174 decreases over various testing iterations, the significance of that particular test goal 38 is decreased such that the test goal may no longer used depending on an associated threshold score 40. Conversely, where a TG score 174 increases over testing iterations, the test goal may be used more frequently.

With regard to calculating TS score 162, in one embodiment, each test script 180 has at least one output having one of four results: a warning, an error, a failure and a pass. A successful result for a test script 180 occurs only if no failures and no errors are returned. The meaning of each result varies depending on what the test script 180 is configured to test. Relative to one illustrative application in which test script 180 attempts to open and execute a file: A warning may indicate, for example, “I cannot open file, will wait.” A pass may indicate, for example, “I tried to open file, and did so.” An error may indicate, for example, “I tried to open file, and could not find it.” A failure may indicate: “I opened file, but could not execute file.”

In order to determine a TS test score 162, each result can have a score weighting 42 assigned thereto indicating the significance of the result. To achieve a TS test score 162, a number of each result (i.e., warning, error, failure, pass) can be summed for a test session, and divided by the weight. The total of each of these factors can be summed for a test session to attain a TS test score 162 for each test script 180. Scores for a particular test script 180 can be used, for example, to determine whether the test script is capturing the necessary information. Similarly to a test goal, where TS score 162 decreases over various testing iterations, the significance of that particular test script 180 may decrease such that the test script is no longer used. Conversely, where a TS score 162 increases over testing iterations, the test script can be used more frequently.

It should be recognized that the above methods of calculating scores are meant to be illustrative only, and other techniques are possible and considered within the scope of the invention.

E. Correct Failures and Repeat

In a fifth step S5, failures discovered during testing are corrected, and steps S1-S4 may be repeated for the corrections. Correction may include practically any now known or later developed addition, deletion, adjustment, etc., to a component of system 10 (FIG. 1). The process may then be repeated until all test goals 38 have been achieved. If necessary, once a correction has been made, additions/deletions/adjustments can also be made to test scripts 180 and/or test goals 38. In this fashion, ATS 20 is highly adaptable. In one example, a software developer may have to make amendments to the changes in new software release. In this case, TMG 102 can suggest new test maps 152 if required, which can be used for testing new/modified functionality in the new software release. Tester 104 can also modify a test map 152 depending on modification of existing functionality in the new software release.

F. Modeling

In another optional step S6, test modeler 108 is used to generate further model rules 164 based on TM and TS results 154, 160. Test modeler 108 may include any now known or later developed mechanism for establishing instructions that ATS 20 can understand, e.g., a graphical user interface, code input, etc. In particular, observational sets of test results obtained from manual and automated testing efforts can be analyzed to find suspected and unsuspected relationships, and to characterize and summarize the test results in novel ways that are both understandable and useful to ATS 20. In one example, modeling may occur when a user 36 notices that when a certain failure occurs in a module 12D (FIG. 1), it causes a communication failure in interface point 14E (FIG. 1). In this case, user 36 may establish a model rule 164 that mandates communication testing of interface point 14E whenever a failure occurs during testing of module 12D.

IV. Conclusion

In the previous discussion, it will be understood that the method steps discussed are performed by a processor, such as PU 24 of ATS 20, executing instructions of program product 32 stored in memory. It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A method for performing automatic testing of a system including a plurality of modules in which at least two modules lack a predetermined communication mechanism, the method comprising the steps of:
establishing at least one test goal for testing regarding at least one of a module and an interface point between modules;
providing at least one test script configured to conduct a test at each module and each interface point;
generating a test map for each test goal, each test map configured to run at least one test script for each module and each interface point in accordance with the test goal; and
automatically testing the system using each test map.

2. The method of claim 1, further comprising the step of scoring a test result for at least one of the test goal and each test script.

3. The method of claim 2, wherein a test script is included in a test map only if the test script has a score that is greater than a threshold score.

4. The method of claim 2, wherein the generating step includes generating a test map for a given test goal only if the given test goal has a score that is greater than a threshold score.

5. The method of claim 1, further comprising the step of recording a test result for each test script.

6. The method of claim 1, further comprising the step of recording each test map.

7. The method of claim 1, further comprising the step of repeating the steps of generating and automatically testing after correction of a failure.

8. The method of claim 1, further comprising the step of modifying the test map based on a modeling rule.

9. A computer program product comprising a computer useable medium having computer readable program code embodied therein for performing automatic testing of a system including a plurality of modules in which at least two modules lack a predetermined communication mechanism, the program product comprising:
program code configured to establish at least one test goal for testing regarding at least one of a module and an interface point between modules, wherein at least one test script configured to conduct a test is provided at each module and each interface point;
program code configured to generate a test map for each test goal, each test map configured to run at least one test script for each module and each interface point in accordance with the test goal; and
program code configured to automatically test the system using each test map.

10. The program product of claim 9, further comprising the program code configured to score a test result for at least one of the test goal and each test script.

11. The program product of claim 10, wherein a test script is included in a test map only if the test script has a score that is greater than a threshold score.

12. The program product of claim 10, wherein the generating program code generates a test map for a given test goal only if the given test goal has a score that is greater than a threshold score.

13. The program product of claim 9, further comprising program code configured to modify the test map based on a modeling rule.

14. A system for performing automatic testing of a system including a plurality of modules in which at least two modules lack a predetermined communication mechanism, the system comprising:
means for establishing at least one test goal for testing regarding at least one of a module and an interface point between modules, wherein at least one test script configured to conduct a test is provided at each module and each interface point;
means for generating a test map for each test goal, each test map configured to run at least one test script for each module and each interface point in accordance with the test goal; and
means for automatically testing the system using each test map.

15. The system of claim 14, further comprising means for scoring a test result for at least one of the test goal and each test script.

16. The system of claim 15, wherein a test script is included in a test map only if the test script has a score that is greater than a threshold score.

17. The system of claim 15, wherein the generating means generates a test map for a given test goal only if the given test goal has a score that is greater than a threshold score.

18. The system of claim 14, further comprising means for recording a test result for each test script and each test map.

19. The system of claim 14, further comprising means for repeating the steps of generating and automatically testing after correction of a failure.

20. The system of claim 14, wherein the generating means includes means for modifying the test map based on a modeling rule.
